(19) United States
(12) Patent Application Publication
(10) Pub. No.: US 2026/0238692 A1
(43) Pub. Date: Aug. 13, 2026

(54) METHOD AND APPARATUS FOR IMPROVING A CONTROL PLANE STACK ARCHITECTURE

(71) Applicant: SAMSUNG ELECTRONICS CO., LTD., Suwon-si, Gyeonggi-do (KR)

(72) Inventors: Morteza KHEIRKHAH, Staines, Middlesex (GB); David Gutierrez ESTEVEZ, Staines, Middlesex (GB); Mahmoud WATFA, Staines, Middlesex (GB)

(21) Appl. No.: 19/469,301

(22) PCT Filed: Mar. 27, 2024
(86) PCT No.: PCT/KR2024/003863

§ 371 Date: Sep. 25, 2025

(30) Foreign Application Priority Data
Mar. 29, 2023 (GB) 2304575.0
Feb. 29, 2024 (GB) 2402930.8

(51) Int. Cl. H04L 67/02; H04W 28/02; H04W 80/12

(52) U.S. Cl. CPC H04L 67/02; H04W 28/0252; H04W 80/12

(57) ABSTRACT

The present disclosure relates to a 5G communication system or a 6G communication system for supporting higher data rates beyond a 4G communication system such as long term evolution (LTE). Disclosed is a method of communicating between a User Equipment, UE, a Network Function, NF, of a Core Network, CN, of a telecommunication network, and a Base Station, gNB, wherein a layer is provided in a protocol stack, the layer being positioned above an RRC layer and being arranged to facilitate the use of Service Based Interfaces, SBI.

### TECHNICAL FIELD

The present invention relates to an improved Control Plane, CP, Protocol Stack Architecture to Support Service Based Interface for Next Generation Radio Access Network, NG-RAN, and User Equipment, UE.

### BACKGROUND ART

Considering the development of wireless communication from generation to generation, the technologies have been developed mainly for services targeting humans, such as voice calls, multimedia services, and data services. Following the commercialization of 5G (5 th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6 th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems.

In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

Currently, there are needs to improving a control plane stack architecture in wireless communication system.

### Solution to Problem

According to embodiments of the present disclosure, a method performed by a terminal in a wireless communication system is provided. The terminal comprises a layer above an RRC layer in a protocol stack, for facilitating service based interfaces, SBI. The method comprises: transmitting all messages to base station at first instance via the layer, wherein the SBI relates to hypertext transfer protocol, HTTP, wherein the layer comprises an evolved access stratum, eAS, layer.

According to embodiments of the present disclosure, a terminal in a wireless communication system is provided. The terminal comprises a layer above an RRC layer in a protocol stack, for facilitating service based interfaces, SBI. The terminal comprises: a transceiver; and a controller coupled with the transceiver and configured to: transmit all messages to base station at first instance via the layer, wherein the SBI relates to hypertext transfer protocol, HTTP, wherein the layer comprises an evolved access stratum, eAS, layer.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows 5G System Architecture, known in the art;

FIG. 2 shows non-Roaming 5G System Architecture in reference point representation, known in the art;

FIG. 3 shows a high-level system architecture for 6G control plane of the protocol stacks at UE, gNB and AMF, according to an embodiment of the invention;

FIG. 4 shows an eAS layer operating in parallel to the NAS and NGAP layers according to an embodiment of the invention;

FIG. 5 shows a further 2 layers introduced according to an embodiment of the invention; and FIG. 6 shows how known NAS and NGAP layers are extended to support SBI, according to an embodiment of the invention.

FIG. 7 is a block diagram illustrating a structure of a user equipment (UE) according to embodiments of the present disclosure;

FIG. 8 is a block diagram illustrating a structure of a base station (BS) according to embodiments of the present disclosure; and FIG. 9 is a block diagram illustrating a structure of a network entity (NE) according to embodiments of the present disclosure.

Throughout the drawings, it should be noted that like reference numbers are used to depict the same or similar elements, features, and structures.

### BEST MODE FOR CARRYING OUT THE INVENTION

A key innovation in Fifth Generation, 5G, system architecture compared to Evolved packet Core, EPC, is the introduction of Service-Based Architecture (SBA). With SBA, every network function in the 5G Core, 5GC, such as Access and Mobility Management Function, AMF, Session Management Function, SMF, Unified Data management, UDM, Policy Control Function, PCF, etc., can communicate with another network function via RESTful Application Programming Interface, APIs, over an HTTP protocol. A transport protocol (e.g., TCP, UDP, SCTP, etc.) should be utilized to carry HTTP payloads.

The SBA simplifies interactions between Network Function, NFs, given that interfaces can be defined at the application layer and they can be easily expandable. For example, if the AMF wishes to interact with a newly proposed NF in 5GC, then this can be performed by a simple software update.

With SBA, each network function expresses its functionalities through Service-Based Interfaces (SBI), which include a set of services. Each service includes a set of service operations (i.e., a set of RESTful APIs). This way, an NF can be a service producer, and a set of other NFs can be a service consumer.

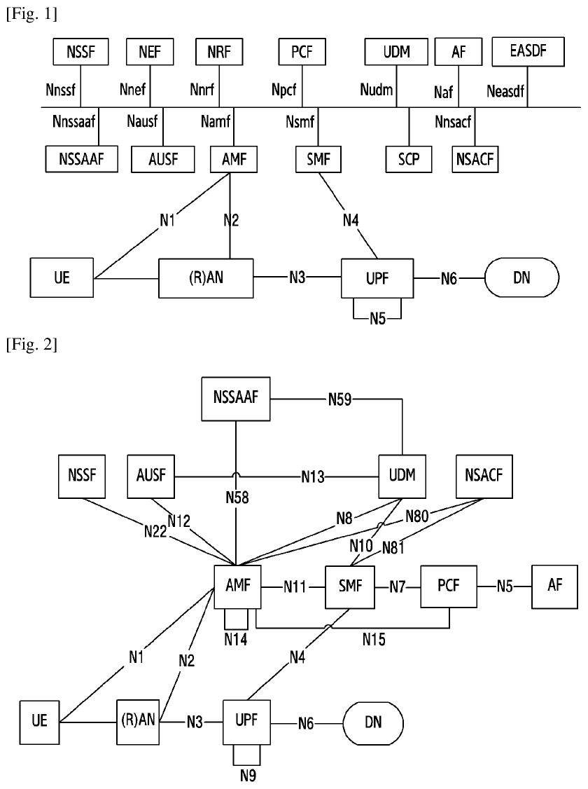

FIG. 1 shows 5G System Architecture, known in the art;

FIG. 1 shows a high-level architecture of 5GC where several NFs are connected to one another via a bus. Typically, a Service Communication Proxy (SCP) governs communications between NFs in 5GC. SCP provides several benefits for 5GC networks such as load balancing, routing, message periodization, overload control, etc.

In FIG. 1, the interfaces N1, N2, N3, N4, and N6 do not support SBI while any interface name that starts with “Nxx” supports SBI (e.g., Npcf, Naf, Namf, etc.).

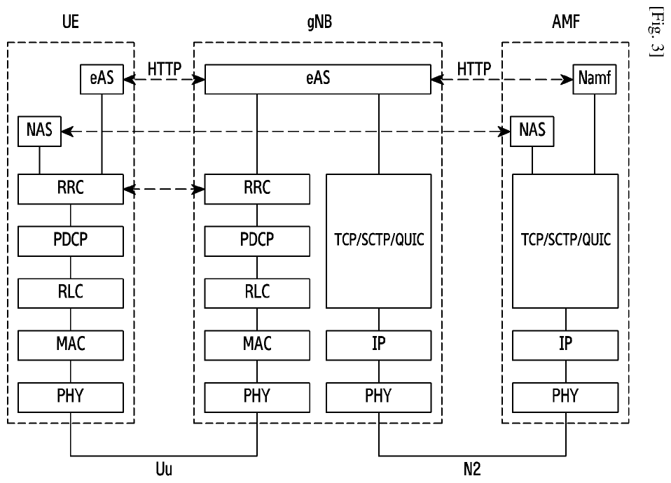

FIG. 2 shows non-Roaming 5G System Architecture in reference point representation, known in the art;

FIG. 2 illustrates a non-roaming 5G system (5GS) architecture with some key NFs interacting with one another. As is clear, AMF is well connected to other NFs, given that it is an anchor point for relaying messages from NG-RAN and UE over N2 and N1 reference points, respectively. Similarly, SMF is also connected to several other NFs because it manages Protocol Data Unit, PDU, sessions.

SBA architecture has brought significant flexibility to 5GC. Every NF in 5GC can easily interact with another one directly via HTTP signaling over only a few message types (e.g., subscribe-notify or request-response). The only 5GC interface that does not follow SBA is N2, connecting NG-RAN to 5GC (more specifically AMF) over Next-Generation Application Protocol, NGAP.

With this conventional Peer-to-Peer, P2P, model (of N2), if RAN components wish to interact with network function in 5GC, they should pass through the AMF and also the NGAP APIs should be extended. In other words, direct communication between NG-RAN and NFs in 5GC is not feasible, a serious roadblock in merging new time-sensitive services in 5GC to support NG-RAN. For example, some entities of emerging RAN architectures (e.g., C-RAN or O-RAN) may end up residing in 5GC and/or require interaction with 5GC NFs directly, and without having AMF in between unnecessarily. A notable example is “gNB-CU-CP” which can reside in 5GC, directly interacting with 5GC NFs such as Network Data Analytics Function, NWDAF, Location management function, LMF, PCF, SMF, etc.

Additionally, the N2 interface transports the NAS signaling (i.e., N1) between UE and 5GC (AMF) transparently. The AMF is an anchor point in all these interactions between UE and 5GC (e.g., SMF, PCF, UDM, etc.). However, in most procedures, the AMF only relays information between UE and 5GC and thus it will not consume any of that information locally. With this model, for any new services between UE and 5GC, at least the NAS layer and NGAP layers should be updated/extended.

That said, with the prior art 5G architecture, interactions between UE and NG-RAN are also very limited, which could present a roadblock for the deployment of modem services, such as AI/ML-based services, in NG-RAN and/or UE.

In particular, the following are problems encountered in the prior art:
Support for direct interactions between components in NG-RAN and NFs in 5GC (e.g., NWDAF, LMF, Remote Interference Management, RIM, Self Organising Network, SON, LMF, Public Warning System, PWS, UE Radio Capability Signaling Optimization, RACS).
Lack of support for direct interactions between components in UE and NFs in 5GC.
Lack of support for direct interactions between components in UE and NG-RAN.
Prevent the AMF from being a bottleneck (from both network and computational perspectives) while permitting NG-RAN/UE components to interact with NFs in 5GC.
Lack of support for RAN entities (e.g., gNB-CU-CP and/or RIC) to be able to reside in 5GC, directly interacting with NFs.

It is an aim of embodiments of the present invention to address problems in the prior art, whether mentioned herein or not.

According to the present invention there is provided an apparatus and method as set forth in the appended claims. Other features of the invention will be apparent from the dependent claims, and the description which follows.

The following summarize main aspects of this invention:
In one solution, a new layer operates on top of the RRC layer to support SBI, known as “evolved AS” (eAS). This layer terminates at gNB. As such, it provides the following benefits which do not exist in the current 3 5G architecture:
   Components at UE, including applications, may interact with components at NG-RAN (directly) and vice versa.
   Components at UE may interact with NFs in 5GC (directly) and vice versa.
   Components at NG-RAN may interact with NFs in 5GC and/or components/applications at UE (directly), and vice versa.
   This layer may potentially unify required APIS between UE, RAN and CN so that components at these entities may interact with one another easily. Therefore, each entity may flexibly support new services.
In a related solution, the eAS layer may operate on top of an existing signalling radio bearer (e.g., SRB1 or SRB2) or a new dedicated RRC signalling radio bearer will be defined between UE and gNB. This way, the RRC layer only encapsulates the HTTP traffic from/to UE or gNB.
In a related solution, the eAS layer at gNB may be able to interact directly with 5GC over HTTP, replacing the NGAP layer.
In a related solution, the RRC layer at UE and/or gNB will carry some new RRC signalling so that the gNB and/or UE will be able to indicate the destination of the packets they are carrying via RRC, e.g., whether it is destined for UE, NG-RAN or CN. A new IE may be defined in existing RRC messages (e.g., UL NAS transport) or a new RRC message can be defined.
In one solution, a new layer (eAS) operates in parallel to the NAS and NGAP layers so existing procedures can remain intact while the eAS can be used for emerging or modern services such as AI/ML. This new layer (eAS) may interact with NAS and NGAP and also can be transported via the RRC signalling over the Uu interface to gNB. From gNB its traffic may be transported to 5GC over HTTP.
In one solution, the UE may extend the NAS transport to interact with 5GC. This extension may be implemented via a new layer on top of the NAS layer, which supports SBI. This layer may be referred to as “eNAS”. The key idea here is to permit NFs in 5GC to get access to components at UE, and the other way around, via the NAS transport. The gNB may also extend the NGAP layer by having a new layer atop, supporting SBI. The new layer may be referred to as “evolved NGAP” (eNGAP). The eNGAP layer permits NG-RAN components to interact directly with NFs in 5GC.
In one solution, a new network function is proposed in 5GC (let's refer to it as “Nep”), which can be connected to a base station (gNB) directly over NGAP while it interacts with other NFs in 5GC via SBI, acting similarly to AMF but only with the responsibility of relaying CP traffic back and forth between NG-RAN and 5GC.
In one solution, a network function in 5GC may support NGAP (protocol stack) in parallel to their current SBI. For example, SMF can interact with NG-RAN (more specifically, gNB) directly. Other examples could be LMF, NWDAF, PCF, etc.

According to a first aspect of the present invention, there is provided a method of communicating between a User Equipment, UE, a Network Function, NF, of a Core Network, CN, of a telecommunication network, and a Base Station, gNB, wherein a layer is provided in a protocol stack, said layer being positioned above an RRC layer and being arranged to facilitate the use of Service Based Interfaces, SBI.

In an embodiment, said layer at the UE forwards all messages to the gNB at first instance.

In an embodiment, the use of SBI further facilitates the use of HTTP for communication between the UE, the gNB and the NF.

In an embodiment, the layer is an evolved Access Stratum, eAS, layer.

In an embodiment, traffic on the eAS layer is carried via a dedicated Signalling Radio Bearer, SRB.

In an embodiment, a component with the gNB is operable to communicate directly with a component within the CN or in the UE.

In an embodiment, the component is a Location Management Function, LMF, or Session Management Function, SMF.

In an embodiment, the layer is provided in addition to a Next-Generation Application Protocol, NGAP, layer and operates in parallel thereto.

In an embodiment, there is further provided the step of providing a network function, Ncp, in the CN, which can be connected to the gNB directly, while it interacts with other NFs in the CN, having the task of relaying Control Plane, CP, traffic back and forth between NG-RAN and CN.

In an embodiment, with regard to the eAS layer, the UE indicates to the RRC layer whether incoming packets from the eAS layer are destined for NG-RAN and/or CN and/or gNB and the eAS layer is arranged to carry this indication to gNB so that the gNB will know how to forward this packet further.

In an embodiment, the eAS layer has Interfaces/APIs to communicate with the RRC layer.

According to a second aspect of the present invention, there is provided apparatus arranged to perform the method of the first aspect.

Although a few preferred embodiments of the present invention have been shown and described, it will be appreciated by those skilled in the art that various changes and modifications might be made without departing from the scope of the invention, as defined in the appended claims.

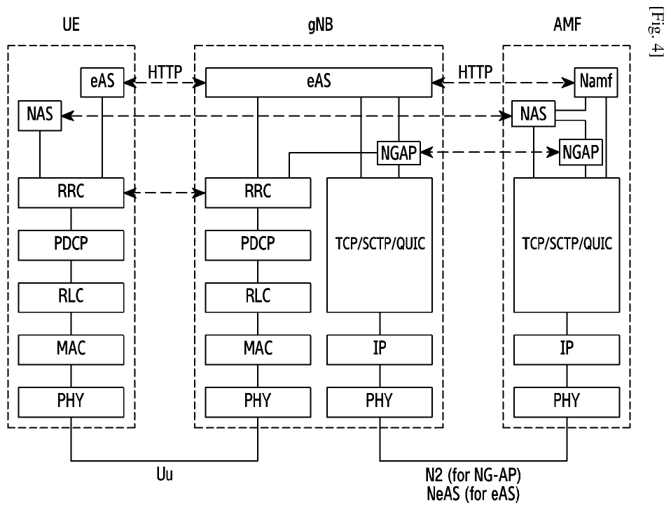

Note that in FIGS. 3 to 6, an AMF is depicted as a NF in the Core Network with which the UE is communicating via the gNb. However, note that the AMF is exemplary only and is primarily shown for backward compatibility reasons. An embodiment of the invention is arranged to facilitate communication between the UE and defined ones of the NFs in the CN.

In a first embodiment, evolved Access Stratum (eAS) traffic is carried via a signaling radio bearer (SRB), replacing the non-access stratum (NAS) and NGAP layers.

In this embodiment, a new layer may be included within the control plane of the radio protocol stack known as the “evolved Access Stratum (eAS)”. The eAS terminates at the base station, gNB, and supports the service-based interface (SBI) that operates over HTTP. This way, applications running at the UE side can use the eAS layer to interact with components at NG-RAN (e.g., RAN Intelligent Control and/or gNB). This layer may utilize JavaScript Object Notation, JSON, for its interactions which is platform independent data formatting.

FIG. 3 shows the high-level 6G control plane architecture of the protocol stacks at UE, gNB and AMF. Components at UE may communicate to the eAS layer directly via HTTP (i.e., via RESTful APIs) or other means/interfaces depending on the platform/OS. The eAS layer at UE forwards all messages to gNB via HTTP at the first instance. The messages can be further forwarded from the gNB to their destinations, e.g., at NG-RAN and/or 5GC and/or gNB, via HTTP. The eAS at gNB may interact with any NFs of 5GC through the Service Communication Proxy (SCP). Overall, following this principle, UE and/or NG-RAN may host several network functions (similar to 5GC) and become service producers and/or consumers.

In one solution, the eAS layer may operate on top of the RRC layer (i.e., control plane) as depicted in FIG. 3. This means that the RRC layer should encapsulate the HTTP traffic arriving from the eAS layer and then de-capsulate it when passing it to the eAS layer at gNB. This way, the RRC signaling should be extended to support such new interactions over the Uu interface, for example, over a new signaling radio bearer (e.g., SRBx) or existing signaling radio bearer (e.g., SRB1 or SRB2). A new dedicated RRC signaling message can be defined for transporting such payload or existing UL NAS transport can be extended (by means of new Information Elements (IEs) to support these new interactions.

Having said that, the RRC layer only transports the traffic coming from the eAS layer, encapsulating at UE and decapsulating at gNB for the UL traffic and the other way around for the DL traffic. Therefore, the RRC signaling may not need to be extended extensively. Most RESTful APIs (related to new services and service operations) should be implemented at the eAS layer.

If UE's signaling is destined for 5GC, then the eAS layer at gNB may forward the related packets to 5GC, and this can be done directly by gNB given that the eAS at gNB can dynamically open a TCP/UDP socket for this transportation. This way, the eAS layer acts as a relay, but relaying may occur within the same layer through intra-layer function calls (i.e., the relaying may occur over a single protocol stack).

In addition, the UE may need to indicate to the RRC layer whether the incoming packets from the eAS layer is destined for NG-RAN and/or 5GC and/or gNB. The eAS layer should also carry this indication to gNB so that the gNB will know how to forward this packet further, whether it is itself, NG-RAN or 5GC.

A note should be taken that when the eAS layer is proposed at gNB with aim of interacting with NFs in 5GC directly (and replacing then NGAP layer), then existing services and service operations of 5GC's NFs (e.g., Namf) may need be updated to support these new interactions.

The eAS layer should have required Interfaces/APIs to communicate with the RRC layer and other UE components (e.g., applications). Separate interfaces/APIs can be defined for these interactions. For example, the eAS layer can communicate with UE's applications via RESTful APIs, while it may follow the conventional inter-layer system calls for interacting with the lower layers (e.g., RLC, MAC, PHY layers).

Similarly, the eAS layer at gNB can directly interact with NG-RAN components such as RAN Intelligent Controller (RIC).

With 3GPP Centralized RAN (C-RAN) architecture, the above flexibility becomes even more evident because the Central Unit (CU) and the Distributed Unit (DU) are separated, and the CU may reside in the 5GC as a network function, so interactions between CU and DU for the control plane may be easier to be done over HTTP signaling. As the CU becomes more fluid, then it can be instantiated in a different part of the network quite flexibly, and thus, the DUs can decide which CUs to connect to, providing good load-balancing within the converged (RAN and CN) network. That said, the CU could also benefit from 5GC network functions for accessing to reach data analytics (e.g., from NWDAF) and/or other modern services such as Artificial Intelligence/Machine Learning (AI/ML), etc.

In a second embodiment, the eAS layer exists in parallel to the NGAP and NAS layers.

In this scenario, messages arriving from UE to gNB (over a signaling radio bearer SRB) can be further forwarded to their destinations directly via HTTP over a transport protocol (e.g., TCP, SCTP, QUIC, etc.). This way, the gNB will be an anchor point for exchanging messages between UE, RAN and CN, acting similarly to the AMF in the current 5G architecture. In other words, for example, messages that are supposed to be transported between UE and 5GC via NAS over RRC and NGAP, can now be transported over RRC and HTTP (bypassing the N2 interface).

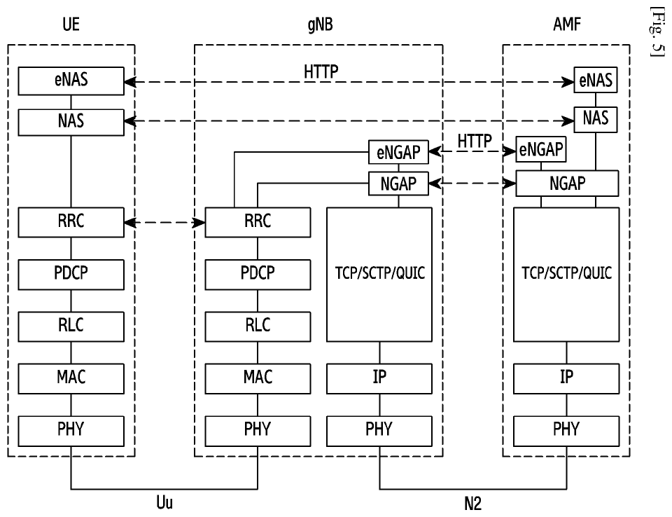

This approach can be used for new modern services such as AI/ML, e.g., components at NG-RAN and UE can directly interact with CN's NFs such as NWDAF. FIG. 4 shows an eAS layer operating in parallel to the NAS and NGAP layers according to an embodiment of the invention. FIG. 4 shows a new control plane architecture where the eAS layer operates in parallel to the NAS and NGAP layers.

The NGAP and eAS layers can operate over the same protocol stack (i.e., TCP/ IP/PHY) as shown in FIG. 4. Currently, the NGAP traffic uses a reliable transport protocol such as TCP or SCTP because in-order packet delivery is an important matter for procedures between gNB and AMF. However, the eAS layer, transporting HTTP traffic to/from UE and/or NG-RAN and/or 5GC, may use an unreliable transport protocol such as UDP that does not concern packet losses or packet ordering.

The choice of a transport protocol, such as TCP (reliable) or UDP (unreliable), may be different in different scenarios/interactions. For example, a gNB (i.e., eAS at gNB) may prefer using UDP to interact with NWDAF while using TCP with SMF or PCF.

In another scenario, the eAS layer may be required to use the NGAP for interacting with some existing NFs in 5GC. This way, if the request comes from UE then either the RRC layer at gNB should make this forwarding decision or the eAS layer at gNB should forward the message to the NGAP layer at gNB which then forwarded to an NF in 5GC via AMF.

In a third embodiment, the eAS layer operates on top of the NAS and NGAP layers.

In this solution, the UE may extend the NAS transport to interact with 5GC. This extension could be done by proposing a new layer on top of the NAS layer, which supports SBI. The new layer may be referred to as “evolved NAS” (eNAS). The eNAS layer can directly interact with components at UE via SBI. However, interactions between UE's components and 5GC's NFs should be performed via the NAS layer. In other words, the NAS layer would transport packets between UE and 5GC as of the current architecture, only enabling new services to emerge on both sides.

A key aspect of this solution is to permit NFs in 5GC to get access to components (e.g., applications) at UE, and the other way around, via the NAS transport, which is secured and integrity protected.

This solution requires small modifications to the NAS layer because the NAS layer only encapsulate/decapsulate the packets from/to the eNAS layer. The eNAS layer would permit new services to emerge without needing to change the NAS layer.

However, this extension does not permit NG-RAN/gNB to interact with UE, given that the eNAS layer terminates at AMF rather than gNB. Additionally, when UE is not registered in the network and thus the NAS transport is not established, the eNAS may not be used.

In another solution, the gNB/NG-RAN may extend the NGAP layer so that components at NG-RAN can interact with NFs of 5GC directly (similar to eNAS idea discussed earlier). This extension could be done via having a new layer on top of NGAP, which support SBI. The new layer may be referred to as “evolved NGAP” (eNGAP). The eNGAP layer can directly interact with components at NG-RAN via SBI. This way, the N2 interface would not be significantly changed other than supporting the eNGAP layer by means of encapsulating/de-capsulating traffic from/to eNGAP. Additionally, interactions between NG-RAN/gNB and 5GC is still performed through AMF. FIG. 5 shows a further 2 layers introduced according to an embodiment of the invention. FIG. 5 highlights this solution.

Overall, a key aspect in this solution is to permit NFs in 5GC to get access to NG-RAN components via SBI operating on top of NGAP. For example, this idea permits the RIC platform in Open RAN to host several xApps which require to interact with 5GC directly, e.g., for collecting data and analytics. In other words, xApps can act as service producers and/or consumers, similar to NFs in 5GC.

It is important to note that the eNGAP layer may be an application running close to the radio protocol stack of the gNB, interacting with its NGAP layer. In the case of the C-RAN, the eNGAP may be hosted on the DU.

In a fourth embodiment, the NAS and NGAP layers are extended to support SBI.

In this solution, the NAS and NGAP layers may be extended directly to support SBI. This solution makes sense particularly with C-RAN architecture, where each layer of a radio protocol stack is software-based, and thus, adding a new interface with a set of new APIs in each layer is not an issue. FIG. 6 shows how known NAS and NGAP layers are extended to support SBI, according to an embodiment of the invention. This is illustrated schematically in FIG. 6.

With this model, new services (and their corresponding APIs) can be simply supported by these layers while existing procedures are left intact. For example, applications at the UE may directly interact (e.g., over HTTP) with the NAS layer and exchange their messages with NFs in 5GC. Similarly, NG-RAN components can interact with NGAP over SBI, where HTTP messages are transported by the NGAP layer to the AMF.

In another embodiment, a new network function can be proposed in 5GC (e.g. “Ncp”), which can be connected to a base station directly over NGAP while it interacts with NFs in 5GC via SBI (over HTTP), acting similarly to AMF but only with the responsibility of relaying control plane traffic back and forth between NG-RAN and 5GC. This way, multiple instances of Ncp can be established and connected to a single gNB if needed, for example, for load-balancing purposes serving a single or multiple gNB. Therefore, if control plane traffic between NG-RAN and 5GC grows large in volume, multiple instances of Ncp can be established dynamically in the same or different part of the 5GC network (e.g., different pods) and/or over different network slices. This approach may solve the problem of having a single AMF per UE or multiple UEs. Additionally, it permits modern services such as AIML, which require the transmission of a large amount of data (e.g., model transfer) between 5GC and NG-RAN/UE, to be used widely in 3GPP networks. It is envisaged that in 6G networks, 5GC may require to transfer of ML models to entities in NG-RAN and UE.

In one solution, other network functions in 5GC may support NGAP in parallel to their current SBI. For example, SMF can interact with NG-RAN (more specifically, gNB) directly. Other examples could be LMF, NWDAF, PCF, etc.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

FIG. 7 is a block diagram illustrating a structure of a UE according to an embodiment of the disclosure.

As shown in FIG. 7, the UE according to an embodiment may include a transceiver 710, a memory 720, and a processor 730. The transceiver 710, the memory 720, and the processor 730 of the UE may operate according to a communication method of the UE described above. However, the components of the UE are not limited thereto. For example, the UE may include more or fewer components than those described above. In addition, the processor 730, the transceiver 710, and the memory 720 may be implemented as a single chip. Also, the processor 730 may include at least one processor. Furthermore, the UE of FIG. 7 corresponds to the UEs of FIGS. 1-6.

The transceiver 710 collectively refers to a UE receiver and a UE transmitter, and may transmit/receive a signal to/from a base station or a network entity. The signal transmitted or received to or from the base station or a network entity may include control information and data. The transceiver 710 may include a RF transmitter for upconverting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the UE.

Also, the memory 720 may store control information or data included in a signal obtained by the UE. The memory 720 may be a storage medium, such as read-only memory (ROM), random access memory (RAM), a hard disk, a CD-ROM, and a DVD, or a combination of storage media.

The processor 730 may control a series of processes such that the UE operates as described above. For example, the transceiver 710 may receive a data signal including a control signal transmitted by the base station or the network entity, and the processor 730 may determine a result of receiving the control signal and the data signal transmitted by the base station or the network entity.

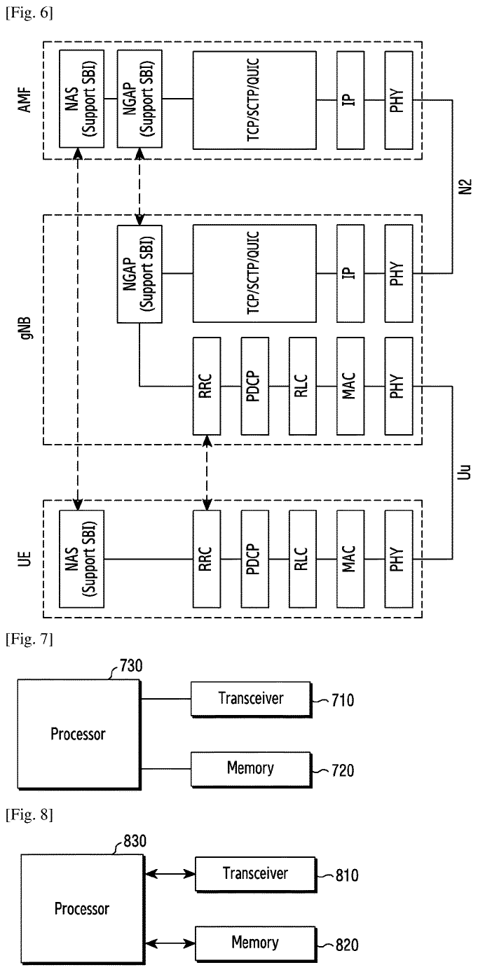

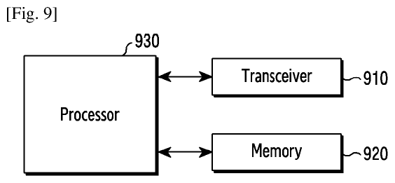

FIG. 8 is a block diagram illustrating a structure of a base station according to an embodiment of the disclosure.

As shown in FIG. 8, the base station according to an embodiment may include a transceiver 810, a memory 820, and a processor 830. The transceiver 810, the memory 820, and the processor 830 of the base station may operate according to a communication method of the base station described above. However, the components of the base station are not limited thereto. For example, the base station may include more or fewer components than those described above. In addition, the processor 830, the transceiver 810, and the memory 820 may be implemented as a single chip. Also, the processor 830 may include at least one processor. Furthermore, the BS of FIG. 8 corresponds to the gNBs of FIGS. 3-6.

The transceiver 810 collectively refers to a base station receiver and a base station transmitter, and may transmit/receive a signal to/from a terminal (UE) or a network entity. The signal transmitted or received to or from the terminal or a network entity may include control information and data. The transceiver 810 may include a RF transmitter for up-converting and amplifying a frequency of a transmitted signal, and a RF receiver for amplifying low-noise and down-converting a frequency of a received signal. However, this is only an example of the transceiver 810 and components of the transceiver 810 are not limited to the RF transmitter and the RF receiver.

Also, the transceiver 810 may receive and output, to the processor 830, a signal through a wireless channel, and transmit a signal output from the processor 830 through the wireless channel.

The memory 820 may store a program and data required for operations of the base station. Also, the memory 820 may store control information or data included in a signal obtained by the base station. The memory 820 may be a storage medium, such as read-only memory (ROM), random access memory (RAM), a hard disk, a CD-ROM, and a DVD, or a combination of storage media.

The processor 830 may control a series of processes such that the base station operates as described above. For example, the transceiver 810 may receive a data signal including a control signal transmitted by the terminal, and the processor 830 may determine a result of receiving the control signal and the data signal transmitted by the terminal.

FIG. 9 is a block diagram illustrating a structure of a network entity (NE) according to embodiments of the present disclosure.

As shown in FIG. 9, the network entity of the present disclosure may include a transceiver 910, a memory 920, and a processor 930. The transceiver 910, the memory 920, and the processor 930 of the network entity may operate according to a communication method of the network entity described above. However, the components of the terminal are not limited thereto. For example, the network entity may include more or fewer components than those described above. In addition, the processor 930, the transceiver 910, and the memory 920 may be implemented as a single chip. Also, the processor 930 may include at least one processor. Furthermore, the network entity illustrated in FIG. 9 may correspond to the AMF entity, NWDAF entity, LMF entity, PCF entity, SMF entity, UPF entity, or UDM entity, etc. illustrated in FIG. 1 or AMF entity illustrated in FIGS. 3-6.

The transceiver 910 collectively refers to a network entity receiver and a network entity transmitter, and may transmit/receive a signal to/from a base station or a UE.

The signal transmitted or received to or from the base station or the UE may include control information and data. In this regard, the transceiver 910 may include a RF transmitter for up-converting and amplifying a frequency of a transmitted signal, and a RF receiver for amplifying low-noise and down-converting a frequency of a received signal. However, this is only an example of the transceiver 910 and components of the transceiver 910 are not limited to the RF transmitter and the RF receiver.

Also, the transceiver 910 may receive and output, to the processor 930, a signal through a wireless channel, and transmit a signal output from the processor 930 through the wireless channel.

The memory 920 may store a program and data required for operations of the network entity. Also, the memory 920 may store control information or data included in a signal obtained by the network entity. The memory 920 may be a storage medium, such as ROM, RAM, a hard disk, a CD-ROM, and a DVD, or a combination of storage media.

The processor 930 may control a series of processes such that the network entity operates as described above. For example, the transceiver 910 may receive a data signal including a control signal, and the processor 930 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local area network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as ‘component', 'module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

A description of an embodiment with several components in communication with each other does not imply that all such components are required. On the contrary a variety of optional components are described to illustrate the wide variety of possible embodiments of the disclosure.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article or a different number of devices/ articles may be used instead of the shown number of devices or programs. The functionality and/or the features of a device may be alternatively embodied by one or more other devices which are not explicitly described as having such functionality/features. Thus, other embodiments of the disclosure need not include the device itself.

The specification has described a method and apparatus for selecting a selective security mode for applying selective security and flow management for selective security for User Equipment (UE) under mobility. Further, the specification has described a method and apparatus for flow management for selective security during the handover. The illustrated steps are set out to explain the embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

1. A method performed by a terminal in a wireless communication system, wherein the terminal comprises a layer above an RRC layer in a protocol stack, for facilitating service based interfaces, SBI, the method comprising:
transmitting all messages to base station at first instance via the layer,
wherein the SBI relates to hypertext transfer protocol, HTTP,
wherein the layer comprises an evolved access stratum, eAS, layer.

2. The method of claim 1, wherein traffic on the eAS layer is carried via a dedicated signalling radio bearer, SRB.

3. The method of claim 1, wherein the BS communicate directly with a component within the core network, CN or the terminal.

4. The method of claim 3, wherein the component comprises a location management function, LMF entity, or session management function, SMF entity.

5. The method of claim 1, wherein the layer is provided in addition to a next-generation application protocol, NGAP, layer and operates in parallel to the NGAP layer.

6. The method of claim 1, further comprising providing a network function, Ncp, in the CN,
wherein the Ncp is connected to the BS directly,
wherein the Ncp interacts with other network function, NFs in the CN, relaying control plane, CP, traffic back and forth between NG-RAN and the CN.

7. The method of claim 1, further comprising:
indicating to the RRC layer whether incoming packets from the eAS layer are destined for NG-RAN and/or CN and/or gNB, and wherein the eAS layer is arranged to carry this indication to BS.

8. The method of claim 1, wherein the eAS layer comprises application programming interfaces, APIs for communicating with the RRC layer.

9. A terminal in a wireless communication system, wherein the terminal comprises a layer above an RRC layer in a protocol stack, for facilitating service based interfaces, SBI, the terminal comprising:
a transceiver; and
a controller coupled with the transceiver and configured to:
transmit all messages to base station at first instance via the layer,
wherein the SBI relates to hypertext transfer protocol, HTTP,
wherein the layer comprises an evolved access stratum, eAS, layer.

10. The terminal of claim 9, wherein traffic on the eAS layer is carried via a dedicated signalling radio bearer, SRB.

11. The terminal of claim 9, wherein the BS communicate directly with a component within the core network, CN or the terminal,
wherein the component comprises a location management function, LMF entity, or session management function, SMF entity.

12. The terminal of claim 9, wherein the layer is provided in addition to a next-generation application protocol, NGAP, layer and operates in parallel to the NGAP layer.

13. The terminal of claim 9, wherein the controller is further configured to provide a network function, Nep, in the CN,
wherein the Ncp is connected to the BS directly,
wherein the Ncp interacts with other network function, NFs in the CN, relaying control plane, CP, traffic back and forth between NG-RAN and the CN.

14. The terminal of claim 9, wherein the controller is further configured to indicate to the RRC layer whether incoming packets from the eAS layer are destined for NG-RAN and/or CN and/or gNB, and
wherein the eAS layer is arranged to carry this indication to BS.

15. The terminal of claim 9, wherein the eAS layer comprises application programming Interfaces, APIs for communicating with the RRC layer.
